(19) United States
(12) Patent Application Publication
(10) Pub. No.: US 2007/0268136 A1
(43) Pub. Date: Nov. 22, 2007

(54) Methods and apparatus for determining and using distance information for distances between RFID transceivers and RFID tags

(75) Inventors: Andrew Jeremy Adamec, Buford, GA (US); Albert M. G. Claessen, Oakwood, GA (US)

Correspondence Address: PAUL W. MARTIN, NCR CORPORATION, LAW DEPT., 1700 S. PATTERSON BLVD., DAYTON, OH, 45479-0001, US

(73) Assignee: NCR Corporation, Dayton, OH (US)

(21) Appl. No.: 11/435,957

(22) Filed: May 17, 2006

(51) Int. Cl. G08B 13/14

(52) U.S. Cl. 340/572.1

(57) ABSTRACT

Techniques for determining the distance between an RFID radio transceiver and an RFID tag. An RFID reader interrogates or otherwise communicates with an RFID tag by transmitting a carrier signal to the tag. The RFID tag modulates the carrier signal with an information signal and returns a reflected carrier signal to the reader. The reader analyzes properties of the reflected carrier signal, computes values related to the reflected carrier signal, and uses known values related to the transmitted carrier signal and values obtained from analyzing and processing the reflected carrier signal to compute the distance between the RFID tag and the reader.

### FIELD OF THE INVENTION

The present invention relates generally to improved methods and apparatus for radio frequency identification (RFID) tag sensing, and more particularly to advantageous techniques for determining the distance between an RFID radio transceiver and an RFID tag and using such distance information in order to enhance information provided by the tag.

### BACKGROUND OF THE INVENTION

RFID tags are becoming more and more commonly used in retail and other environments. Large retailers are moving from having every pallet of merchandise identified with an RFID tag to insisting that every individual item of certain types of products either have an RFID tag today or at some date in the future. With the increasing utilization of RFID tags, the density of the tags to be read or interrogated is increasing. In addition, a single installation, such as a retail store or a warehouse, may implement a number of RFID readers, and a single RFID tag may be within communication range of two or more RFID readers at the same time. In many instances, it would be highly advantageous for a device using an RFID reader to identify a tag as being within a specified distance from the device. For example, a checkstand could advantageously identify RFID tags within a prescribed distance and use predefined rules to determine that those items were involved in a checkout transaction at the checkstand. A monitor installed at a warehouse door could identify RFID tags within a prescribed distance as passing into or out of the warehouse through the door at which the monitor is installed. However, typical prior art techniques for distance determination, such as triangulation, are difficult or impossible to use effectively for determination of distance to RFID tags, particularly in an environment in which RFID tags are present in large numbers and at high densities.

### SUMMARY OF THE INVENTION

Among its several aspects, the present invention addresses such difficulties by analyzing characteristics of responses returned by an RFID tag and determining the distance to a tag based on the analysis. An RFID reader interrogates or otherwise communicates with an RFID tag by transmitting a carrier signal to the tag. The RFID tag modulates the carrier signal with an information signal and returns a reflected carrier signal to the reader. The reader analyzes properties of the reflected carrier signal, computes values related to the carrier signal, and uses the computed values to compute the distance between the RFID tag and the reader. The values used to compute the distance are the wavelength of the carrier wave, an integer number of wavelengths of the carrier wave between the RFID tag and the reader, and an additional difference value representing the difference between the integer multiple of the wavelength of the carrier wave and the total distance between the RFID tag and the reader. The wavelength of the carrier wave is typically known because the communication frequency is deliberately selected and therefore known. Therefore, computation of the integer multiple of the wavelength and computation of the difference value will yield a value for the distance from the reader to the RFID tag.

These and other features, aspects and advantages of the invention will be apparent to those skilled in the art from the following detailed description taken with the accompanying drawings.

### BRIEF DESCRIPTION OF THE DRAWINGS

FIG. 1 shows an exemplary retail environment in which an RF interrogator in accordance with the present invention may be suitably employed;

FIG. 2 shows details of an exemplary RF interrogator in accordance with the present invention;

FIG. 3 shows a process for determining the distance between an RFID tag and an RF interrogator in accordance with the present invention; and

FIG. 4 shows a process of management of goods according to an aspect of the present invention.

### DETAILED DESCRIPTION

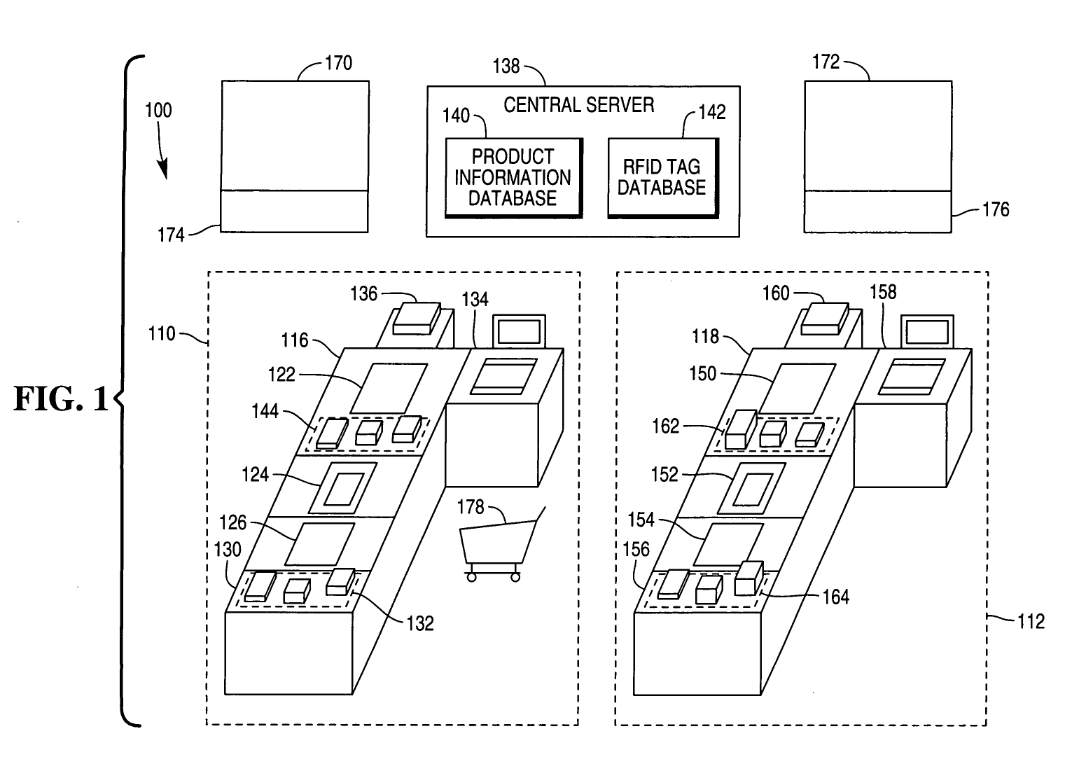

FIG. 1 shows an exemplary retail environment 100 in which the present invention may be advantageously employed. FIG. 1 shows two checkout lanes 110 and 112. Adjacent each checkout lane is a corresponding checkout stand or checkstand 116 and 118, respectively.

Checkstand 116 includes a first conveyor belt 122, an integrated scanner and scale combination 124, a second conveyor belt 126, and a bagging collection area 130 where a group of products 132 awaits bagging. Checkstand 116 also includes a data processing unit for managing information of interest, such as information about the products. In the present exemplary embodiment supporting purchase or sales transactions in a retail establishment, the data processing unit is part of a point of sale (POS) terminal 134, but numerous other data processing units may be used in systems employing the teachings of the present invention, such as an inventory tracking center for management of a warehouse, for example.

In the present embodiment, the checkstand 116 includes an RFID tag reader or interrogator 136 in accordance with the present invention. The point of sale terminal communicates with a central server 138. The central server 138 includes one or more databases useful for identifying products and RFID tags and for processing transactions. In the present exemplary case, the central server 138 hosts a product information database 140 and an RFID tag database 142. The product information database 140 includes product identification and price information, as well as RFID tag information identifying RFID tags attached to products. The RFID tag database 142 includes information useful for identifying and communicating with RFID tags. For example, the RFID tag database 142 may include an entry for each tag, with each entry including a RFID tag identifier, information identifying the tag as belonging to a particular type, and operational information relating to the tag, such as communication frequencies used by the tag.

Suitably, the interrogator 136 identifies tags within a particular range when called on to do so, for example, when a transaction is being conducted at the checkstand 116 and it is desired to identify tags within an area designated for products being entered into a purchase transaction using the checkstand 116. The interrogator 136 may first issue a general broadcast to all tags, and receive and note responses for all tags within range. The response from a tag can be expected to include an identifier for the tag. Once all tags within range are identified, the interrogator 136 may individually query each tag within range in order to establish the distance between the interrogator 136 and each particular tag. The range information for each tag is passed to the point of sale terminal 134, which examines and uses the range information as appropriate. For example, the range information may be analyzed to determine whether a tag, and by implication the product to which the tag is affixed, is within an area for products being entered into a transaction using the checkstand 116.

It will be recognized that the checkstand 116 is shown as exemplary only and that the RFID tag reader could be suitably employed with any checkstand commonly employed today or in a checkstand to be developed in the future so long as it was desirable to determine the distance from an RFID tag reader or interrogator. In addition, an interrogator such as the interrogator 136 may be put to numerous other uses. For example, an interrogator may be deployed at a warehouse door as part of a security arrangement. The interrogator may monitor detect tags within a particular range of the door and may issue an alert if position and inventory information relating to the goods to which the tag is affixed indicates that the goods are not expected to be brought near the door at that time. Numerous other uses of distance determination by an interrogator may be contemplated.

In the particular exemplary context discussed here, that of determination of distance to tags in a retail environment, determination of distance may be performed in order to discriminate between multiple RFID tags in a dense tag environment, as discussed further below. Suitably, a range defining an area of interest, such as an area where goods may be assembled for purchase, is designated. All RFID tags within that range are identified, and the information that these particular tags is within the designated range is used as desired.

For example, FIG. 1 illustrates the product group 132 in the bagging area 130, as well as a product group 144, placed near the first conveyor belt 122. Depending on the chosen operation of the checkstand 116 in a particular transaction, one of a number of different distance values may be chosen so as to designate tags, and the products bearing those tags, as being within or outside an area of interest. To continue the example, the product grouping 132 is at the bagging area 130 and some distance away from the interrogator 136. The product grouping 144 is near the first conveyor belt 122, and nearer the interrogator 136 than is the product grouping 132. Depending on the choices made for managing transactions conducted at the checkstand 116, distance values may be set so as to include both the grouping 132 and the grouping 144 within an area of interest, to include the grouping 144 and exclude the grouping 132, or to define still other limits of an area of interest.

It may be desired, for example, to define an area for products being presented for purchase so as to encompass products such as the product grouping 144, and other products in the vicinity of the first conveyer belt 122. Products such as the grouping 132, and other products in the bagging area, may be considered to have already been entered into a transaction and therefore not within the area of interest. In such a case, only products within a relatively short distance from the interrogator 136 will be defined as within the area of interest.

As an alternative, the area of interest may be defined so as to include the checkout lane 110 as a whole, encompassing all products in the area of the checkout lane 110 but excluding products in other checkout lanes, such as the lane 112, and also excluding products in a display area such as the shelves 170 and 172 and the end caps 174 and 176. Such an area of interest would encompass the product groupings 132 and 144, as well as products in the shopping cart 178. If desired, a customer could simply place the shopping cart 178 in an appropriate position in the vicinity of the checkstand 110, for example, in a marked location. The customer or an attendant could use the point of sale terminal to initiate a transaction. Under the direction of the point of sale terminal 134, the interrogator 136 would identify all RFID tags within a designated distance defining the checkout lane 110. The interrogator 136 would pass the identifiers received from these tags to the point of sale terminal 134, which would then retrieve product information from the database 140. The identified products would be entered into the transaction, and the transaction could be concluded and payment tendered without a need to enter each product into the transaction individually.

The checkstand 118 includes similar elements to those found in checkstand 116, including a first conveyor belt 150, a scanner scale combination 152, a second conveyor belt 154, a bagging area 156, a point of sale terminal 158, and an interrogator 160. Product groupings 162 and 164 are shown placed on the checkstand 118.

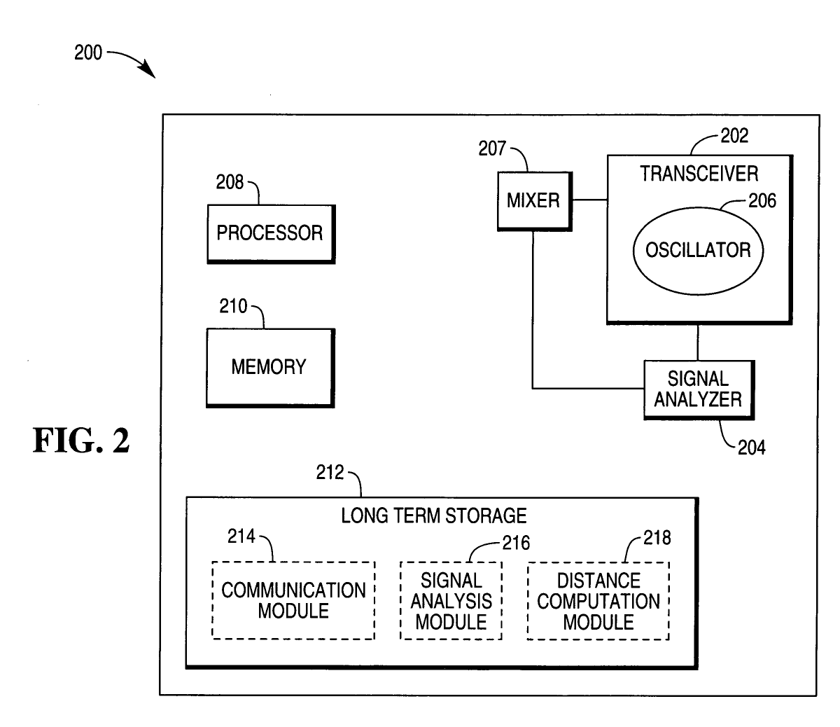

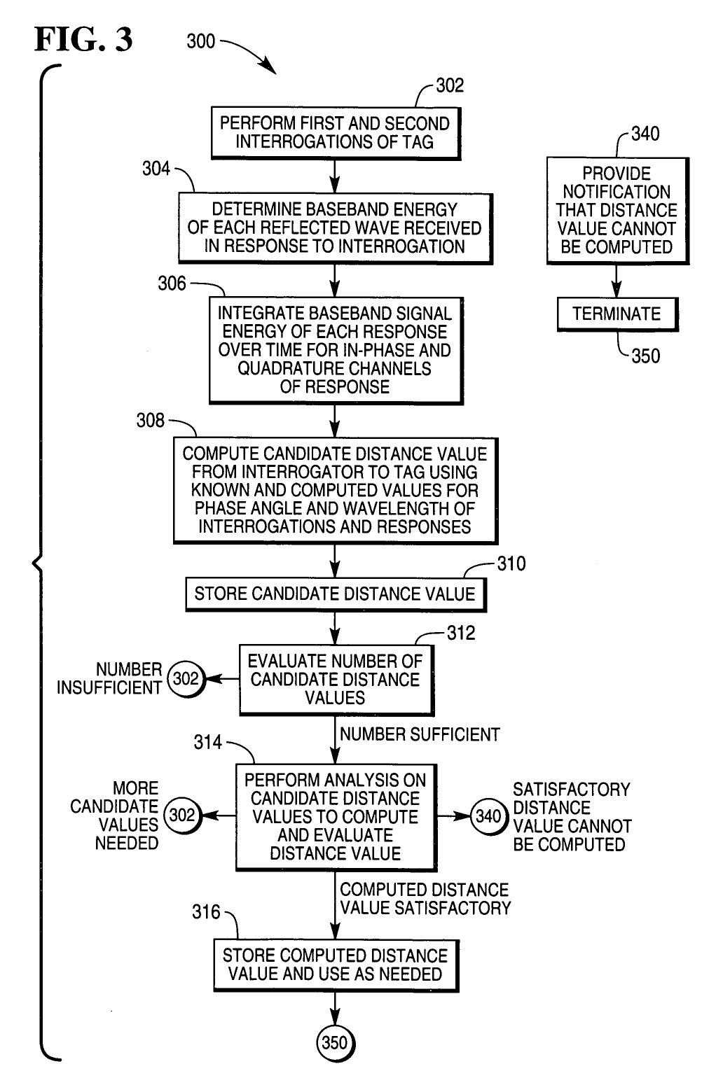

Depending on the retailer's requirements, some, many or all of the products making up the product groups 132, 144, 162 and 164, as well as the products on the shelves 170 and 172, the products on the end caps 174 and 176, the products in shopping carts, such as exemplary cart 178, as well as products in additional display areas (not shown) adjacent the checkstands 116 and 118, may have RFID tags thereon. As discussed further below in connection with FIGS. 2 and 3, each of the interrogators 136 and 160 can determine the distance between itself and each of the RFID tags it detects. Consequently, each of the readers 136 and 160 can detect that an RFID tag affixed to an item is within an area of interest in the vicinity of the checkstand 116 or 118, respectively. At the same time, each of the readers 136 and 160 can detect that a tag that is not within such an area of interest, even though the RFID tag may be within a range allowing communication with the reader.

FIG. 2 shows further details of an RFID tag interrogator 200 in accordance with the invention, which may suitably be employed as the interrogators 136 and 160 of FIG. 1. The interrogator 200 includes a transceiver 202 and a signal analyzer 204. The transceiver 202 is preferably a heterodyne or homodyne transceiver, using a local oscillator 206 to perform a baseband downconversion. The interrogator 200 further includes a mixer 207, for mixing a transmitted and a reflected signal, as is discussed in greater detail below.

The interrogator 200 also includes a processor 208, memory 210, and long term storage 212. The interrogator 200 employs a communication module 214, a signal analysis module 216, and a distance computation module 218, suitably hosted in the long term storage 212 and transferred to memory 210 as needed for execution by the processor 208. The communication module 214 manages the operation of the transceiver 202, preparing and formatting transmissions to be sent to RFID tags and processing messages received from the RFID tags. The signal analysis module 216 directs the operation of the signal analyzer 204 and processes information generated by the signal analyzer 204 in order to obtain values used to perform distance calculations.

In operation, the interrogator 200 transmits queries to RFID tags within range. A query is typically in the form of a radio frequency signal transmitted in the form of a carrier wave. The RFID tag responds by modulating the carrier wave with an information signal and reflecting the modulated carrier wave back to the interrogator 200. As described in greater detail below, characteristics of the reflected signal can be analyzed in order to compute the distance between the interrogator 200 and a particular tag. This distance information can be highly useful, and can serve to facilitate numerous transactions or activities involving products or other objects. For example, a retail checkout system may be designed so that transactions are conducted simply by bringing a collection of products with RFID tags to a checkstand. An interrogator within the checkstand, such as the interrogator 200, queries all RFID tags within range. Suitably, the interrogator first generally broadcasts a query to all tags within range and receives identifiers for those tags. The interrogator then queries each identified tag individually, in the manner described below, in order to obtain information needed to perform distance computation.

In order to allow for distance computation, the signal analyzer 204 analyzes a reflected carrier signal to obtain required signal characteristic information. The processor 208 processes the signal characteristic information to determine the distance to each tag. The distance information may then be used as desired. For example, it may be desired to identify tags within a prescribed distance from a retail checkstand. Products associated with those tags are presumed to be presented for purchase.

In order to determine the distance between the interrogator 200 and a particular RFID tag, the distance computation module 218 of the present invention solves the following equation:

$$d = \frac{wx + z}{2} , \qquad ( 1 )$$

where w is the wavelength of the reflected carrier wave, x is an integer designating the total number of waves, z is the difference between the distance represented by the multiple of the reflected wavelength and the total distance that the reflected wave propagates. In practice, the wavelength w is known and the value of z is determined by measuring the phase difference between the transmitted and the received wave. If these values are known, determining the value of x will yield the value of d.

In order to solve equation (1) above, data resulting from two interrogations of the same RFID tag is obtained. The interrogations may be simultaneous or alternatively may be serially performed. If the interrogations are serially performed, substantially the same conditions must prevail for both interrogations. The position of the RIFD tag must not change, and environmental characteristics affecting the interrogation and response signals must remain the same. If two interrogations are performed, the values of interest and their relationships can be expressed in the form of the following equations:

$$\begin{matrix}{d}_{1} = \frac{{w}_{1} {x}_{1} + {z}_{1}}{2} & ( 2 ) \\ {d}_{2} = \frac{{w}_{2} {x}_{2} + {z}_{2}}{2} & ( 3 )\end{matrix}$$

If a first and second interrogation are performed simultaneously, or under the same conditions, the values of d₁ and d₂ will be equal, simplifying solution of the equations. In order to further simplify solution of equations (2) and (3), the interrogator 200 is preferably configured to operate so that the values of x₁ and x₂ are equal. This equality is achieved through a selection of appropriate values for w₁ and w₂. In order to meet the requirement that x₁ and x₂ are equal, the values of w₁ and w₂ are chosen such that the total propagation distance, d, meets the following criterion:

$$d < \frac{{w}_{1} {w}_{2}}{{w}_{1} - {w}_{2}} , where {w}_{1} < {w}_{2} . \qquad ( 4 )$$

If d₁ and d₂ are equal, and x₁ and x₂ are equal, equations (2) and (3) can be simplified into the following equality:

(w₁x+z₁)=(w₂x+z₂). (5)

This equation yields the following expression for determining the value of x:

$$x = \frac{{z}_{2} - {z}_{1}}{{w}_{1} - {w}_{2}} \qquad ( 6 )$$

The values of w₁ and w₂ are then determined, using the relationship

c=wf, (7)

where c is the velocity of light in a particular environment, w is the wavelength of an electromagnetic wave, and f is the frequency of the wave. The frequency of each of the waves is known, because these are chosen transmission frequencies of the interrogator 200 and the RFID tag being interrogated. The values of w₁ and w₂ are then computed using equation (7), by performing an appropriate computation for each interrogation.

Computation of the values z₁ and z₂ is more complex, and this computation is discussed below.

The interrogator 200 communicates with the various RFID tags through modulated backscatter. The interrogator 200 targets a particular device for communication and transmits a carrier wave, and the device responds by modulating the carrier wave with an information signal. The baseband information signal is typically modulated by the target device on a sub-carrier before the target device modulates it again with the RF carrier wave.

As noted above, the interrogator 200 employs a transceiver 204, which is a heterodyne or homodyne transceiver. The transceiver 202 makes use of the common local oscillator 206 for both the transmitter and receiver to accomplish the baseband downconversion. This architecture insures that both the transmitter and receiver are synchronized to a local oscillator in both frequency and phase.

The carrier wave is transmitted by the interrogator 200 at a known frequency and phase, and the reflected wave returned by the RFID tag is received by the interrogator 200. The transmitted carrier wave and the reflected wave are subjected to a baseband downconversion mixing at the same frequency and phase by the mixer 207. Using this baseband downconversion technique, the tag's baseband signal is extracted from the reflected carrier wave. This baseband downconversion mixing results in two separate in-phase and quadrature signal components that are used by the interrogator 200 to compute the distance to the RFID tag, as discussed further below.

The two components may conveniently be designated I and Q. The component I is the in-phase component, and represents the component of the received signal that is completely in phase with the transmitted wave. The component Q is the quadrature component, and is the component of the received signal that is 90 degrees out of phase with the transmitted wave. If these signals are represented in the complex plane, the in-phase component of the signal lies along the real axis, and the quadrature component lies along the imaginary axis. The output of the mixer 207 may be represented as a function of time by the following equation:

w(t)=x(t)y(t), (8)

where w(t) is the complex output of the mixer 207, x(t) is the RFID tag input signal, and

y(t)=cos(2πft)+j sin(2πft) (9)

where f represents the frequency of the carrier wave transmitted by the transceiver 204. Equation (8) can be rewritten as:

w(t)=x(t)cos(2πft)+jx(t)sin(2πft). (10)

The real in-phase component, I, of the signal is x(t)cos(2πft), and the imaginary quadrature component, Q, is x(t)sin(2πft). For simplicity, this equation can be expressed as:

w(t)=I(t)jQ(t).

The signal received by the interrogator 200 can be visualized as a vector in the complex plane where the in-phase component I is the projection of the vector on the real axis, and the quadrature component Q is the projection of the vector on the imaginary axis. The vector, v, can be described as

v=I+jQ. (11)

The vector v is characterized by a magnitude conveniently expressed as X, and a phase angle, conveniently expressed as θ. Using trigonometric identities, the magnitude, X, of the vector can be expressed in terms of I and Q as follows:

$$X = {( {I}^{2} + {Q}^{2} )}^{\frac{1}{2}} \qquad ( 12 )$$

and the phase angle, θ, can be expressed as

θ=tan⁻¹ [Q/I]. (13)

The signal analysis module 216 employs this trigonometric identity to determine the phase difference between the transmitted carrier wave transmitted by the transceiver 202 and the reflected wave received by the transceiver 202. This phase difference is determined by detecting the amount of modulated backscatter energy reflected by the RFID tag in both the I and Q channels, and using these quantities to calculate the phase difference of the carrier using the trigonometric identity above. The amplitudes of the received modulated baseband signal projected along the real and imaginary axes of the complex plane are proportional to the corresponding amplitudes of the received reflected signal.

The amplitudes of the in-phase and quadrature components of the received signal can be found by examining the spectral content of the signal. This determination can be made using the continuous Fourier transform equation

$$X ( f ) = {\int }_{- ∞}^{∞} x ( t ) {e}^{- j2π ft} d t , \qquad ( 14 )$$

where x(t) is the continuous received signal and f is the frequency of interest.

In an actual operating system, the reflected signal will include an unwanted DC component and a significant amount of additive noise in addition to the original baseband signal. Filtering and spread spectrum techniques are suitably employed to attenuate noise and spread the encoded baseband signal over time, thereby improving the integrated received signal's signal to noise ratio.

However, for the sake of simplicity and in presenting an initial description of the fundamental principles behind determination of distance between the interrogator 200 and an RFID tag, it is assumed that the received signal is an ideal signal and contains no unwanted DC or noise component.

For reasons of simplicity, it can be assumed that the baseband signal is a DC signal. Since the frequency of interest is 0 Hz, the Fourier transform equation (14) can then be rewritten as

$$X ( 0 ) = {\int }_{- ∞}^{∞} x ( t ) d t . \qquad ( 15 )$$

Assuming a noiseless model, the signal analysis module 216 computes the amount of baseband 0 Hz signal energy in the I and Q channels by integrating the received baseband signal energy over time. The integration is performed for each of two frequencies, f₁ and f₂, so the subscript l is used in the equations 16-20 below, with the understanding that l takes on the values 1 and 2.

$$\begin{matrix}{X ( 0 )}_{II} = {\int }_{0}^{t} x ( t ) cos ( 2 π {f}_{l} t ) d t , which may be rewritten as & ( 16 ) \\ {X ( 0 )}_{II} = {\int }_{0}^{t} I ( t ) d t \\ and & ( 17 ) \\ {X ( 0 )}_{Ql} = {\int }_{0}^{t} x ( t ) sin ( 2 π {f}_{l} t ) d t , which may be rewritten as & ( 18 ) \\ {X ( 0 )}_{Ql} = {\int }_{0}^{t} Q ( t ) d t , & ( 19 )\end{matrix}$$

where X(0)_{I1} represents the amplitude of the received DC for the frequency f₁ in-phase channel, I, and X(0)_{QI} represents the amplitude of the received DC for the frequency f₁ quadrature channel, Q. It should be noted that the amplitudes may be positive or negative. Once the signal energy has been computed, the trigonometric identity (13) discussed above can then be used to determine the phase angle of the received signal, yielding the following equation:

$${θ}_{l} = \frac{{tan}^{- 1} [ X ( 0 ) ] {Q}_{l}}{{X ( 0 )}_{Il}} \qquad ( 20 )$$

where θ₁ is a measurement of the difference between the phase of the transmitted wave and the phase of the reflected signal. As noted above, in the present exemplary case the interrogator 200 makes two transmissions, suitably designated f₁ and f₂, so the calculation in equation (20) must be performed for the frequency of each transmission, resulting in phase angles θ₁ and θ₂. It is now possible to solve for z₁ and z₂, used in equation (6) above, since z is simply the fractional part of the transmitted wave represented by θ.

zₙ=wₙθₙ/2π, (21)

where θ is measured in radians. Since w=c/f as discussed above, this expression can be rewritten as

zₙ=(c/f)(θₙ/2π) (22)

Once values for θ₁ and θ₂ have been obtained, all the values needed to compute the distance d₁ are available. As noted above, parameters for the interrogator 200 and the tags have been chosen such that d₁ is equal to d₂ and x₁ is equal to x₂. The distance between the interrogator 200 and the tag being interrogated is given by the following expression:

d₁=d₂=(w₁x₁+z₁)/2. (23)

This expression can be written in terms of the known parameters w₁, w₂, θ₁, and θ₂, as follows:

d₁=d₂={w₁[(w₂(θ₂/2π)−w₁(θ₁/2π))/(w₁−w₂)]+[w₁(θ₁/2π)]}/2. (24)

In order to determine the distance to a tag using the above described principles and computations, the communication module 214 controls the transceiver 202 so as to make two interrogations of the tag, choosing carrier frequencies yielding carrier wavelengths of w₁ for the first transmission and w₂ for the second transmission. The wavelengths w₁ and w₂ are chosen such that such that the values of x₁ and x₂, used in equations (2) and (3) above, are equal. The interrogations are made simultaneously, or within a short time such that neither the distance to the tag nor the environmental characteristics affecting the signal changes significantly between the interrogations. The tag returns responses in the form of modulated and reflected carrier waves. These responses are received by the transceiver and undergo analysis by the signal analyzer 204. Under the control of the signal analysis module 216, the signal analyzer 204 determines values needed to compute the distance between the interrogator 200 and the interrogated tag. For each response, the signal analyzer determines the received baseband signal energy of the response, and the signal analysis module computes this signal energy over time, using the equations (16), (17), (18) and (19). The phase angles θ₁ and θ₂ are computed for each response using equation (20), and passed to the distance computation module 218. The distance computation module 218 computes the distance from the interrogator 200 using equation (24), given the known values of w₁, w₂, θ₁, and θ₂.

Once the distance is computed, the value computed for the distance can be passed to a point of sale terminal, for example, the point of sale terminal 134 of the checkout stand 116, which may use the distance information as described above in connection with the discussion of FIG. 1.

The procedure above can be extended to encompass any frequency of interest. Rewritten equations incorporating any frequency of interest, rather than simply a 0 Hz DC frequency, are used to compute values for θ.

$$\begin{matrix}{X ( {f}_{l} )}_{Il} = {\int }_{0}^{t} x ( t ) {e}^{- j2π {f}_{l} t} cos ( 2 π {f}_{l} t ) d t . \\ Equation ( 25 ) may be rewritten as & ( 25 ) \\ {X ( {f}_{l} )}_{Il} = {\int }_{0}^{t} I ( t ) d t . & ( 26 ) \\ {X ( l )}_{Ql} = {\int }_{- ∞}^{∞} x ( t ) {e}^{- j2π {f}_{l} t} sin ( 2 π {f}_{l} t ) d t . \\ Equation ( 27 ) may be rewritten as & ( 27 ) \\ X ( {f}_{l} ) {Q}_{l} = {\int }_{0}^{t} Q ( t ) d t . & ( 28 ) \\ {θ}_{l} = \frac{{{tan}^{- 1} [ X ( {f}_{l} ) ]}_{Ql}}{{X ( {f}_{l} )}_{Il}} . & ( 29 )\end{matrix}$$

At a frequency of 0 Hz, equations (25)-(29) simplify to equations (16)-(20), respectively.

Once values for θ₁, which in the present example are values for θ₁ and θ₂, have been computed, these values can be used in equations to compute the distance between the interrogator 200 and the tag:

zₙ=wₙθₙ/2π. (21)

zₙ=(c/f)(θₐ/2π). (22)

d₁=d₂=(w₁x₁+z₁)/2. (23)

d₁=d₂={w₁[(w₂(θ₂/2π)−w₁(θ₁/2π))/(w₁−w₂)]+[w₁(θ₁/2π)]}/2. (24)

Many environments in which an interrogator such as the interrogator 200 may be used are affected by environmental factors, such as signal reflections and noise, leading to potential inaccuracies, the interrogator 200 suitably performs repeated distance calculation repeatedly over numerous combinations of frequencies. The communication module 214 directs the transceiver 202 to transmit pairs of interrogation signals at the chosen frequencies, and responses received from each pair of interrogation signals are used by the distance calculation module 218 to generate candidate distance values. The distance computation module 218 examines the candidate distance values to determine if they will yield a reliable distance computation. For example, it is typically expected that the set of candidate distance values generated will exhibit a small standard deviation. If the standard deviation of the set of candidate distance values is within predetermined limits, the distance computation module 218 suitably uses the mean of the candidate distance values as the actual distance to the tag. If the standard deviation of the set of candidate distance values falls outside the predetermined limits, the distance computation module suitably rejects the candidate distance values and either makes another attempt to determine the distance, or alternatively determines that the distance cannot be computed. The determination that the distance cannot be computed suitably comes after repeated failed attempts to determine distance, or under other circumstances indicating that a failure to determine distance cannot be overcome.

FIG. 3 illustrates a process 300 of determination of distance from an RFID interrogator to an RFID tag according to an aspect of the present invention. At step 302, first and second interrogations of a tag are performed. The interrogations are simultaneous, or alternatively may be closely spaced in time so that neither the distance from the interrogator to the tag nor the conditions affecting the interrogation signal or the return signal change significantly between the interrogations. The interrogations are in the form of carrier waves having known frequencies, with the RFID tag responding by modulating the carrier wave and returning a reflected carrier wave. The frequencies chosen for the carrier waves transmitted by the RFID interrogator are chosen such that the number of wavelengths of the reflected wave is the same for each interrogation.

At step 304, upon receiving each reflected wave, the received baseband energy of the response is determined. At step 306, the baseband signal energy of each response is integrated over time for the in-phase and quadrature channels of the response, in order to determine the phase angle of each response. At step 308, the wavelengths and phase angles of the interrogation signals and the return responses are used to compute a candidate distance value from the interrogator to the tag. At step 310, the candidate distance value is stored.

At step 312, the number candidate distance values that has been stored is optionally evaluated, for example, by comparing the number against a predetermined criterion evaluated to determine if a sufficient number of candidates has been stored. If an insufficient number has been stored, the process returns to step 302. If a sufficient number has been stored, the process proceeds to step 314.

At step 314, statistical analysis is suitably performed on the candidate distance values to compute and evaluate a computed distance value for the distance from the interrogator to the tag. Statistical analysis may include taking the mean of the candidates and computing the standard deviation for the data set. The analysis may also include consideration of whether or not the computed distance value has changed, for example, since the last iteration or over several iterations. The analysis may also include consideration of whether or not the computed data appear to be reliable, for example, whether or not the standard deviation of the data set is within a prescribed range. If the analysis indicates that additional iterations are needed, the process returns to step 302. If the analysis indicates that a reliable value cannot be computed, the process skips to step 340 and suitable actions are taken, such as alerting an attendant that a failure to compute a distance value has occurred. The process then terminates at step 350. If the analysis indicates that a reliable value has been computed, the process proceeds to step 316 and the computed distance value is stored and used as needed. The process then terminates at step 350.

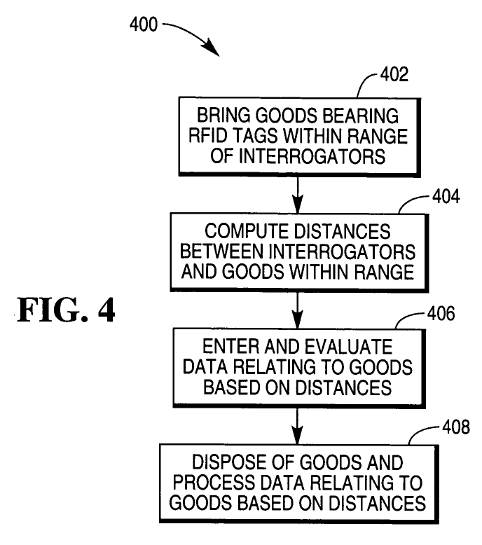

FIG. 4 illustrates a process 400 of management of goods according to an aspect of the present invention. At step 402, goods bearing radio frequency identification tags are brought within range of one or more interrogators. At step 404, distances between each interrogator and tags within range of the interrogator are computed. At step 406, depending on the computed distance between the interrogators and the tags, data entries relating to the goods are made and evaluated. For example, associations may be constructed between goods and between goods and interrogators according to their distances from the interrogators. To carry the example further, an assembly of goods within a predetermined distance from an interrogator associated with the checkout stand may be associated with one another and determined to be goods placed at the checkout stand for entry into a sales transaction.

At step 408, goods are disposed of and data processed based in part on the distance computations. For example, goods may be entered into sales transactions at a checkstand based on evaluations of the proximity between the goods and a checkstand.

While the present invention has been disclosed in a particular context, it will be recognized that it may be suitable applied to a variety of environments in which RFID tags are and will be employed.

We claim:

1. An interrogator for communicating with a radio frequency identification tag, comprising:
a transceiver for sending a transmitted carrier wave to the tag and receiving a reflected carrier wave returned by the tag;
a signal analyzer for determining selected characteristics of the reflected carrier wave; and
a processor for receiving signal characteristic information relating to the selected characteristics of the reflected carrier wave and determining the distance between the tag and the interrogator based on the signal characteristic information.

2. The interrogator of claim 1, wherein the transmitted carrier wave is transmitted at a known frequency and phase and the known frequency and phase information for the transmitted carrier wave and the signal characteristic information for the reflected carrier wave are used in determining the distance between the tag and the interrogator.

4. The interrogator of claim 3, wherein the signal characteristic information includes in-phase and quadrature components of a baseband signal associated with the reflected carrier wave.

4. The interrogator of claim 3, wherein determining the distance between an interrogator and a tag includes performing more than one interrogation of the tag, with each interrogation being performed using a different carrier wave frequency, wherein the signal analyzer determines signal characteristics of the carrier wave during each interrogation, and wherein the processor uses frequency information and signal characteristic information relating to each interrogation in determining the distance between the interrogator and the tag.

5. The interrogator of claim 4, wherein determining the distance between an interrogator and a tag includes performing a plurality of interrogations of the tag to generate a plurality of candidate distance values and performing statistical analysis on the candidate distance values to compute and evaluate a distance value indicating the distance between the interrogator and the tag.

6. The interrogator of claim 5, wherein performing statistical analysis includes evaluating a standard deviation of the candidate distance values to determine if the standard deviation exceeds an allowable value for a reliable distance value computation.

7. The interrogator of claim 5, wherein performing statistical analysis includes evaluating the candidate distance values over a plurality of iterations to determine if the computed distance value is converging or is stable.

8. The interrogator of claim 4, wherein all interrogations made in determining the distance between the interrogator and the tag are made under substantially identical conditions relating to the distance between the interrogator and the tag and affecting the transmitted carrier wave and the reflected carrier wave.

9. A system for management of goods, comprising:
a plurality of radio frequency identification tags, each tag being affixed to an item;
a plurality of interrogators, each interrogator being operative to interrogate a tag, to receive an identifier of a tag being interrogated, and to determine the distance between the interrogator and the tag being interrogated; and
one or more data processing units for managing information relating to the items, the data processing unit being able to receive tag identification information and distance information from one or more interrogators, each data processing unit being operative to perform appropriate operations relating to an item to which the tag is affixed based on the tag identification and the distance information.

10. The system of claim 9, further comprising a product information database including product information for each of a plurality of products, information for each product including product identification information and tag identification information for a tag affixed to the product.

11. The system of claim 10, wherein the data processing unit is a point of sale terminal, and wherein the point of sale terminal uses tag identification and distance information to determine whether a product associated with the tag is within an area of interest.

12. The system of claim 11, wherein the data processing unit is operative to retrieve product information associated with a tag for which tag identification information has been received.

13. The system of claim 12, wherein the data processing unit is operative to enter product information into a purchase transaction when tag identification and distance information indicates that the product is within an area of interest.

14. A method of determining a distance from an interrogator to a radio frequency identification tag, comprising the steps of:
performing two interrogations of the tag, each interrogation being performed by transmitting a transmitted carrier wave to the tag, the transmitted carrier waves having different frequencies;
for each interrogation, receiving a reflected carrier wave and performing signal analysis on the reflected carrier wave to obtain signal characteristic information for the reflected carrier wave; and
computing a distance from the tag to the interrogator using frequency and phase information for the transmitted carrier waves and signal characteristic information for the reflected carrier waves.

15. The method of claim 14, wherein the step of performing signal analysis on each reflected carrier wave includes performing a baseband down conversion to extract in-phase and quadrature components of a baseband signal associated with the reflected carrier wave.

16. The method of claim 15, wherein the step of performing signal analysis on each reflected carrier wave includes integrating the baseband signal energy of the reflected wave over time for the in-phase and quadrature channels of the reflected wave, in order to determine the phase angle of each response.

17. The method of claim 16, wherein the signal characteristic information for each reflected wave includes wavelengths and phase angles of the reflected wave.

18. A method for management of objects, comprising the steps of:
determining a distance between a reference point and an object by interrogating a radio frequency identification (RFID) tag affixed to the object and computing the distance to the object based on responses received from the RFID tag; and
determining a disposition of the object based on the distance between the reference point and the object.

19. The method of claim 18, wherein the reference point includes an interrogator in a checkout stand and determining a disposition of the object includes designating the object as included in a sales transaction conducted by the checkout stand.

20. The method of claim 18, wherein the reference point includes an interrogator in a security checkpoint and determining a disposition of the object includes issuing a security alert for the object based on its proximity to the checkpoint.
